(19) United States
(12) Patent Application Publication
(10) Pub. No.: US 2021/0016323 A1
(43) Pub. Date: Jan. 21, 2021

(54) A HIGH THROUGHPUT RATE PARCEL SORTING SYSTEM

(71) Applicant: SOLYSTIC, Bagneux (FR)

(72) Inventors: Patrick HOURS, Saint Peray (FR); Jean RIEU, Saint Georges les Bains (FR)

(21) Appl. No.: 16/956,769

(22) PCT Filed: Jan. 22, 2020
(86) PCT No.: PCT/EP2020/051476

§ 371 Date: Jun. 22, 2020

(30) Foreign Application Priority Data
Jan. 24, 2019 (FR) 1900622

(51) Int. Cl. B07C 3/08; B65G 47/46; B65G 47/84; B65G 17/18

(52) U.S. Cl. CPC B07C 3/082; B65G 47/46; B65G 2201/0285; B65G 17/18; B65G 47/844

(57) ABSTRACT

A sorting system for sorting parcels (2) comprises a first parcel conveyor (3) suitable for conveying the parcels in series in a certain conveying direction (D1), a second parcel conveyor (4) extending above a plurality of sorting outlets that is suitable for conveying the parcels in series. The first and second conveyors have respective contiguous conveying portions (PC) via which the first conveyor feeds the second conveyor with parcels via an injection device (6). The second conveyor is a tray conveyor having trays distributed in series and at constant pitch, each of said trays being mounted to pivot between a tilted position in which it is tilted down along the conveying direction, and a level position in which it is flush with the first conveyor. The system comprises first and second mechanical members that are designed to move the trays between their tilted positions and their level positions.

### TECHNICAL FIELD

The invention relates to the field of systems for sorting parcels or other postal articles, and more particularly “small import packets”.

In the field of international e-commerce, “small import packets” are considered to be small goods of low value. They are sorted and delivered within a few days, and so large-scale logistics centers have been designed that are capable of sorting volumes of the order of one million “small import packets” per day into tens of thousands of different destinations.

Currently, sorting such “small import packets” takes place in a plurality of sorting passes on a packet or parcel sorting system having conveyors, with, between two sorting passes, handling of the packets or parcels that have been put into containers in the sorting outlets so as to inject them again into the feed inlet of the system.

However, in order to make up for the time lost during handling of the packets in the sorting process, the speed at which the packets are conveyed is increased.

Unfortunately, the more the conveying speed increases, the higher the risk of the packets falling off.

Moreover, the large number of destinations of the packets makes it necessary to increase the number of sorting outlets of the machines, thereby increasing their footprint, i.e. the floor area they occupy.

Also, when the flows of packets increase, as they do during festive seasons, the sorting machines require a larger labor force, thereby increasing the operating costs of the logistics centers.

Finally, such packet sorting machines have an occupancy rate that is quite low due to the time necessary for transferring the packets between the inlet of the machine and the outlets.

Sorting systems are also known that are disclosed in Patent Documents JP 2002226035, US 2017/121127 and U.S. Pat. No. 4,709,529.

An object of the invention is to propose a parcel sorting system, in particular for sorting “small import packets”, that does not suffer from those drawbacks.

### SUMMARY OF THE INVENTION

To this end, the invention provides a sorting system for sorting parcels or other postal articles of the parcel or packet type, the sorting system comprising:
a first parcel conveyor suitable for conveying the parcels in series in a certain conveying direction;
a second parcel conveyor of the looped conveyor type extending above a plurality of sorting outlets that is suitable for conveying the parcels in series, said second conveyor being a tray conveyor having trays distributed in series and at constant pitch;

said sorting system being characterized in that said first and second conveyors have respective contiguous and parallel conveying portions via which the first conveyor feeds the second conveyor with parcels, each of said trays being mounted to pivot between a tilted position, in which it is tilted down along the conveying direction, and a level position in which it is brought up to the horizontal and in which it is flush with the first conveyor;

in that said sorting system further comprises:
a first mechanical member designed to co-operate with the trays when they come into said contiguous conveying portion of the second conveyor in order to cause them to pivot into the level positions in which they are brought up to the horizontal;
an injection device mounted on said conveying portion of the first conveyor and comprising piston pushers suitable for moving in said conveying direction in register with and synchronously with the trays of the second conveyor, and for moving transversely relative to said conveying direction so as to transfer the parcels or articles in crosswise translation from the first conveyor to the trays; and
a second mechanical member designed to co-operate with the trays when they leave said contiguous conveying portion of the second conveyor in order to cause them to pivot into the tilted positions.

The sorting system of the invention may have the following features:
in the tilted positions, the trays extend downwards in the direction opposite to the conveying direction in which the parcels are conveyed on the second conveyor;
each tray is provided with a retractable flap mounted to go between a closed position in which it is designed to retain a parcel or other postal article on the tray in the tilted position and an open position in which it is designed to release the parcel or other postal article from the tray in the tilted position, and in that the sorting system further comprises a monitoring and control unit suitable for causing the flap to move into the open position in such a manner that the parcel or article on the tray falls by gravity into an appropriate sorting outlet;
the sorting system further comprises an actuator designed to put the flap into the open position under the control of the monitoring and control unit; and
the flap is mounted to pivot on the tray in such a manner that opening the flap extends the downward tilting of the tray.

The basic idea of the invention is to propose a sorting system that is suitable for conveying the parcels at high speed and stably while also limiting the footprint of the sorting system.

Thus, by means of the contiguous conveying portions of the first and second conveyors and by means of the injection system coordinated with the trays, the transfer of the parcels from the first conveyor to the second conveyor takes place transversely to the conveying direction, in series and at constant pitch.

The presence of flaps makes it possible both to reduce the time required for injecting the parcels onto the second conveyor, and also to make the way they are disposed on the trays more uniform.

The trays and the flaps of the invention are thus also configured to retain the parcels in tilted manner while they are being conveyed, with the tilting being in the direction opposite to the conveying direction.

In addition, by means of the trays being tilted downwards along the conveying direction, sorting outlets can be aligned under the second conveyor in order to enable the parcels to be unloaded longitudinally relative to the second conveyor, thereby greatly limiting the footprint.

The trays being tilted downwards in the direction opposite to the conveying direction in which the parcels are conveyed on the second conveyor also makes it possible to unload the parcels in the direction opposite to the conveying direction by them sliding on the trays, thereby leading to them falling over substantially vertical paths.

It can thus be understood that the more vertical the fall path, the smaller the size of the sorting outlet can be, thereby limiting the footprint of the sorting system accordingly.

### BRIEF DESCRIPTION OF THE DRAWINGS

The present invention will be better understood and other advantages will appear on reading the following detailed description of embodiments given by way of non-limiting example and with reference to the accompanying drawings, in which:

FIG. 1 is a highly diagrammatic view of a sorting system of the invention;

FIG. 2 is a highly diagrammatic view of a portion of the second conveyor of the invention above a plurality of sorting outlets;

FIG. 3 is a highly diagrammatic view of the injection system of the invention and of the contiguous conveying portions of the two conveyors; and

FIG. 4 is a highly diagrammatic view of the first mechanical member of the invention co-operating with trays of the second conveyor.

### DESCRIPTION OF THE EMBODIMENTS

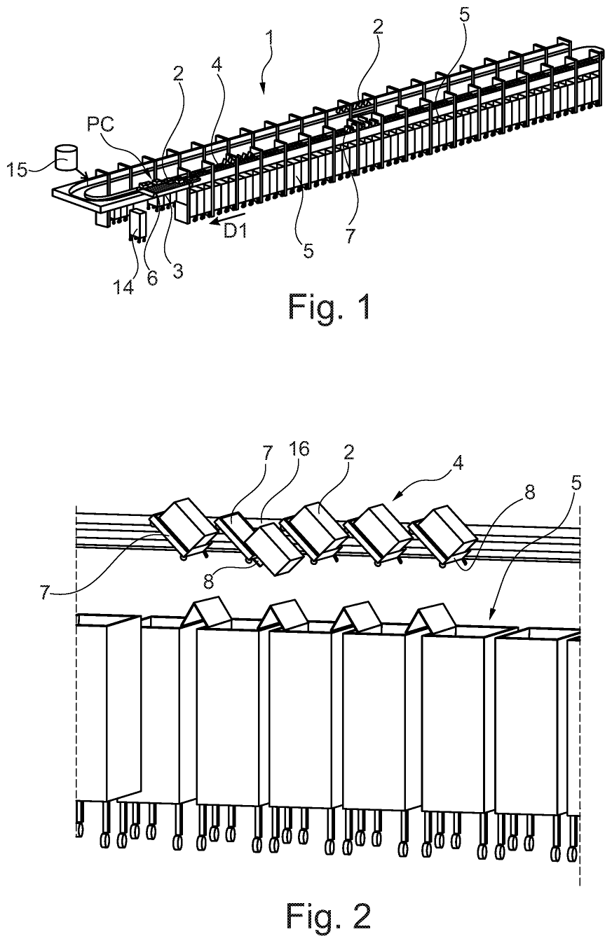

FIG. 1 is a highly diagrammatic perspective view of a sorting system 1 of the invention for sorting parcels 2 or other postal articles such as, for example, “small import packets”.

This sorting system 1 is designed to equip a logistics center for processing parcels.

It comprises a first conveyor 3 suitable for conveying the parcels 2 in series in a certain conveying direction D1.

The sorting system 1 further comprises a second conveyor 4, which, in this example, is a looped tray or platform conveyor that has trays or platforms 7 and that is suitable for conveying the parcels 2 in series above a plurality of sorting outlets 5.

As shown in FIG. 2, the first conveyor 3 and the second conveyor 4 have respective contiguous conveying portions PC via which the first conveyor 3 feeds the second conveyor 4 with parcels by means of an injection device 6.

The trays 7 of the second conveyor 4, which trays can be seen in FIGS. 2, 3, and 4, are suitable for carrying the parcels 2 so as to move them towards sorting outlets 5, at a rate of one parcel per tray 7.

The trays 7 are also distributed in series and at constant pitch in such a manner that the parcels or other articles 2 are conveyed to the sorting outlets 5 in series so as to be unloaded there in a determined order.

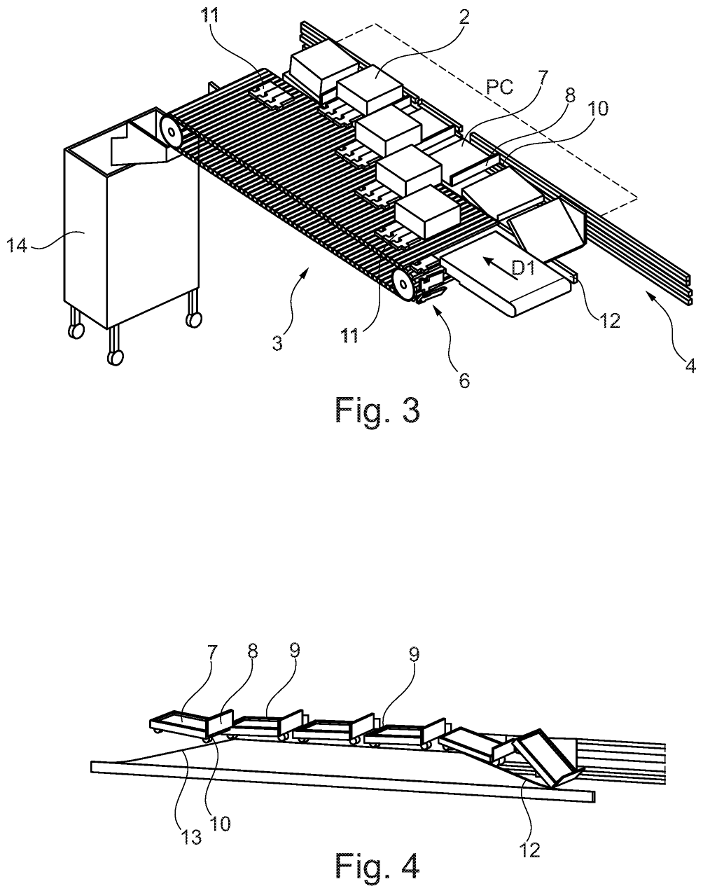

Each of the trays 7 is mounted to pivot between a tilted position in which it is tilted down along the conveying direction D1, which position is adapted for conveying the parcels 2, as shown in FIG. 2, and a non-tilted or “level” position, which is horizontal in this example, and which can be seen in FIGS. 3 and 4, in which position the tray 7 is flush with the first conveyor 3 so as to enable a parcel 2 be transferred by the injection system 6 from the first conveyor 3 to the second conveyor 4.

A flap 8, which can be seen in FIGS. 2, 3, and 4, is also provided along the tilted end of each tray 7 in order to retain the parcel or other postal article 2 loaded on the tray 7 when said tray is in the tilted position.

Abutments 9 may also be provided on the sides and/or other end of the tray 7 in order to prevent the parcel or other article 2 from falling off while it is being injected onto the tray 7.

In this example, the flap 8 is retractable, e.g. by means of a pivot connection 10 making it possible to extend the tilting of the tray 7 downwards and to facilitate falling of the parcel or other article 2 into a sorting outlet 5, as shown in FIG. 2.

The downward tilting of the trays 7 is, in this example, directed in the direction opposite to the conveying direction in which the parcels 2 are conveyed so as to facilitate falling of the parcels 2 in the direction opposite to the direction in which the second conveyor 4 moves.

The horizontal movement of the parcel 2 on the second conveyor 4 is thus cancelled out or at least reduced by the movement in the opposite direction of the parcel 2 on the tray 7, inducing a fall that is substantially vertical.

By means of this configuration, the pitch of the sorting outlets 5 may be reduced considerably.

The injection device 6 comprises piston pushers 11, which can be seen in FIG. 3, and which are mounted on the conveying portion PC of the first conveyor 3 that is contiguous to the second conveyor 4.

The pushers 11 are adapted to move in the conveying direction D1 in register with and synchronously with the trays 7 of the second conveyor 4 in such a manner as to comply with the arrangement of the trays 7 in series and at constant pitch.

The pushers 11 are also suitable for moving transversely relative to the conveying direction D1 so that the parcels 2 that are already moving in the conveying direction D1 are moved in crosswise translation onto the trays 7 of the second conveyor 4.

The sorting system 1 further comprises a first mechanical member 12 designed for bringing the trays 7 up into the level positions when they enter the contiguous conveying portion PC of the second conveyor 4 that is contiguous to the first conveyor 3, which mechanical member 12 is also equipped with a device for closing the flaps.

The first mechanical member 12 is in the form of a main cam fastened to the second conveyor 4 under the trays 7, as shown in FIG. 4, and of a secondary cam (not shown) dedicated to closing the flaps.

The sorting system 1 further comprises a second mechanical member 13 that is designed to tilt the trays 7 into the tilted position when they leave the contiguous conveying portion PC of the second conveyor 4 that is contiguous to the first conveyor 3.

The second mechanical member 13 is also in the form of a cam fastened to the second conveyor 4 under the trays 7, as shown in FIG. 4, but reversed relative to the cam 12 present upstream along the second conveyor 4.

At the downstream end of the first conveyor 3 in the conveying direction D1, a reject container 14 is provided that can be seen in FIGS. 1 and 3 and that is suitable for receiving the parcels 2 that cannot be transferred onto the trays 7 of the second conveyor 4.

Finally, the sorting system 1 further comprises a monitoring and control unit 15 as indicated in FIG. 1, which unit has, in a memory, the list of the parcels 2 present on the second conveyor 4 and also their postal sorting addresses, and is arranged to servo-control the piston pushers 11 to the movement of the trays 7 of the second conveyor 4 in order to perform the transfer at a rate of one parcel or other postal article 2 per tray 7.

The monitoring and control unit 15 is also suitable for causing the retractable flap 8 to open via an actuator 16, e.g. an electromagnetic actuator, so as to release the parcel or other article from the tilted tray 7 and so as to cause it to fall by gravity into an appropriate sorting outlet 5.

In order to perform sorting with a sorting system 1 of the invention, parcels 2 are inserted, in series and at constant pitch, upstream onto the first conveyor 3 so as to be conveyed to the contiguous conveying portion PC of the first conveyor 3 that is contiguous with the second conveyor 4.

The monitoring and control unit 15 then causes the pushers 11 of the injection device 6 to move transversely and synchronously with the pitch of the parcels 2 inserted onto the first conveyor 3 and with the pitch of the trays 7 of the second conveyor 4.

Thus, each parcel or other article 2 moved transversely to the conveying direction D1 by a pusher 11 ends its transverse movement on a dedicated tray 7 that has been positioned in the level position by means of the first mechanical member 12.

The parcel or other postal article 2 loaded on the tray 7 is then tilted with the tray 7 by the mechanical member 13 at the outlet of the contiguous portion PC of the second conveyor 4 that is contiguous with the first conveyor 3.

By means of the flap 8 that acts as an abutment, the parcel or other postal article 2 is conveyed on the tray 7 in the tilted position at high speed and can thus go around bends or turns on the second conveyor 4 without any risk of falling off.

The monitoring and control unit 15 then causes the flap 8 to open via the actuator 16 as soon as the parcel or other postal article 2 is vertically in register with the sorting outlet 5 into which it is to be sorted.

The tray 7 from which the parcel or other postal article 2 has been unloaded then continues to travel so as to finish going round the loop of the second conveyor 4 and so as to come into contact with the first mechanical member 12 and be positioned in the level position in which it is brought back to the horizontal.

The sorting system 1 of the invention may comprise a plurality of first conveyors 3 and a plurality of second conveyors 4 with a plurality of injection devices 6 so as to further increase the throughput rates at which the parcels 2 are processed.

What is claimed is:

1. A sorting system for sorting parcels or other postal articles of the parcel or packet type, the sorting system comprising:
a first parcel conveyor suitable for conveying the parcels in series in a certain conveying direction; and
a second parcel conveyor of the looped conveyor type extending above a plurality of sorting outlets that is suitable for conveying the parcels in series, said second conveyor being a tray conveyor having trays distributed in series and at constant pitch;
wherein said first and second conveyors have respective contiguous and parallel conveying portions via which the first conveyor feeds the second conveyor with parcels, each of said trays being mounted to pivot between a tilted position, in which it is tilted down along the conveying direction, and a level position in which it is brought up to the horizontal and in which it is flush with the first conveyor;
wherein said sorting system further comprises:
a first mechanical member configured to cooperate with the trays when they come into said contiguous conveying portion of the second conveyor in order to cause them to pivot into the level positions in which they are brought up to the horizontal;
an injection device mounted on said conveying portion of the first conveyor and comprising piston pushers suitable for moving in said conveying direction in register with and synchronously with the trays of the second conveyor, and for moving transversely relative to said conveying direction so as to transfer the parcels or articles in crosswise translation from the first conveyor to the trays; and
a second mechanical member configured to cooperate with the trays when they leave said contiguous conveying portion of the second conveyor in order to cause them to pivot into the tilted positions.

2. The sorting system according to claim 1, wherein, in the tilted positions, the trays extend downwards in the direction opposite to the conveying direction in which the parcels are conveyed on the second conveyor.

3. The sorting system according to claim 2, wherein each tray is provided with a retractable flap mounted to go between a closed position in which it is configured to retain a parcel or other postal article on the tray in the tilted position and an open position in which it is configured to release the parcel or other postal article from the tray in the tilted position, and in that the sorting system further comprises a monitoring and control unit suitable for causing the flap to move into the open position in such a manner that the parcel or article on the tray falls by gravity into an appropriate sorting outlet.

4. The sorting system according to claim 3, wherein the sorting system further comprises an actuator configured to put the flap into the open position under the control of the monitoring and control unit.

5. The sorting system according to claim 4, wherein the flap is mounted to pivot on the tray in such a manner that opening the flap extends the downward tilting of the tray.

6. The sorting system according to claim 1, wherein each tray is provided with a retractable flap mounted to go between a closed position in which it is configured to retain a parcel or other postal article on the tray in the tilted position and an open position in which it is configured to release the parcel or other postal article from the tray in the tilted position, and in that the sorting system further comprises a monitoring and control unit suitable for causing the flap to move into the open position in such a manner that the parcel or article on the tray falls by gravity into an appropriate sorting outlet.

7. The sorting system according to claim 6, wherein the sorting system further comprises an actuator configured to put the flap into the open position under the control of the monitoring and control unit.

8. The sorting system according to claim 3, wherein the flap is mounted to pivot on the tray in such a manner that opening the flap extends the downward tilting of the tray.
